(19) United States
(12) Patent Application Publication
(10) Pub. No.: US 2010/0333017 A1
(43) Pub. Date: Dec. 30, 2010

(54) COMPUTER GRAPHIC USER INTERFACE AND DISPLAY SYSTEM

(75) Inventor: David J. Ortiz, Clarence, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: David J. Ortiz, Clarence (US)

(21) Appl. No.: 12/744,805

(22) PCT Filed: Nov. 26, 2008
(86) PCT No.: PCT/US08/13182

§ 371 Date: May 26, 2010

Related U.S. Application Data
(60) Provisional application No. 61/004,339, filed on Nov. 27, 2007.

(51) Int. Cl. G06F 3/048

(52) U.S. Cl. 715/800; 715/853; 715/823

(57) ABSTRACT

An improved computer-implemented graphic user interface comprising a first platform representing a first level of data organization and having a front surface and a top surface, a second platform representing a second level of data organization within the first level of data organization and having a front surface and a top surface, the second platform stacked on the first platform and scaled relative to the first platform such that the top surface of the second platform is smaller than the top surface of the first platform. The interface may further comprise a third platform representing the second layer of data organization within the first level of data organization and having a front surface and a top surface, the second platform and the third platform stacked on the first platform, and the second platform and the third platform scaled relative to the first platform such that the top surfaces of the second and the third platforms are smaller than the top surface of the first platform. The interface may further comprise a third platform representing a third level of data organization within the second level of data organization and having a front surface and a top surface, the third platform stacked on the second platform, and the third platform scaled relative to the second platform such that the top surface of the third platform is smaller than the top surface of the second platform.

### CROSS-REFERENCE TO RELATED APPLICATIONS

This application is a National Stage application of International Application No. PCT/US08/013,182 filed on 2008 Nov. 26, which claims the benefit under 35 U.S.C. §119(e) of U.S. Provisional Application 61/004,339, filed 2007-11-27. The entire content of International Application No. PCT/US08/013,182 is incorporated by reference herein.

### TECHNICAL FIELD

The present invention relates generally to the field of user interfaces for computer operating systems or other software requiring the visual organization of hierarchal information, and more particularly to an improved computer user interface and display system.

### BACKGROUND ART

The Graphical User Interface (GUI) is the graphical representation of data. The desktop is the current metaphor for the computer operating systems' GUI. Metaphors in graphical user interfaces are based on the assumption that the user saves time by taking advantage of the time already spent learning to operate the real world counterpart. For example, users already have experience with written and printed documents and file folders to hold such documents. This can aid in decision-making when using the desktop GUI. The desktop GUI opened the door for a wider range of computer users. It was created at a time when computers were just starting to be mass-produced. The idea of a computer in every home was a revolutionary idea and was the goal. It had to be a system that anyone could learn. The GUI is made up of the prominent metaphors of windows, icons, menus and pointers (WIMP). The desktop GUI is made up of files and folders. Folders can contain files and other folders. The capability of creating and viewing files and folders within other folders defines the hierarchical structure of the desktop.

The desktop is a GUI that relies on direct manipulation. Direct manipulation systems are designed with the principles that they are easier to use than command-line oriented systems since a visual model is created. Reducing the mental workload by allowing users to visually see and recognize information rather than recalling information solely from memory is its advantage. It is easier to recognize a photo you have seen before than to create or verbally describe a previously seen photo. This is known as recognition over recall. The typical example of direct manipulation is to move a file or folder to another folder. Pointing and then dragging elements to the new destination accomplishes this.

Most current computer operating system GUIs operate on a 2D level, although the current desktop GUI is referred to by some as 2.5D because of overlapping windows and 3D effects. The conventional desktop displays files and folders that all look similar. Two different views are possible: a list view and an icon view. The list view simply creates a list of folders and files along the y-axis. The icon view displays the folders and files freely on the x and y-axis. The only possible visual differences between items are the name, the icon, and position they appear in the window. Users typically have to hunt randomly through individual files and folders to find the desired information. After going through one door the hunt starts over again to find the next. This process continues until the user's destination is found.

Two extreme scenarios can describe a user's workflow. Either a user will cover the top or root level with files and folders, or everything is neatly put away. One case has limited use of hierarchy, and the other case uses a deeper hierarchy. It is difficult finding one single folder or file out of an abundance of them. But if the user can immediately find the item, this scenario has the opportunity for accessing the information the fastest. In the next scenario the user must start the long process of navigating from the root location and navigating through folder after folder and so on. This organized scenario should take longer. This user is navigating through an organized structure of information with fewer choices at each level that could aid the user. In reality each user's hierarchal information falls somewhere between the two scenarios. The best individual trait of each scenario is visibility versus structure.

With present systems, the user has to completely refocus every time a new level is revealed. Even after visually finding the next folder, the user still needs to go through the timely hand/eye coordination task of using the mouse to hover over a small area and then click. Then the user must repeat this same task to find and access the next folder. A user can move the mouse and select a file or folder. The novice generally will use a pull down menu and choose file-open. The expert user generally will simply double-click to open, although double-clicking is not much of an accelerator.

Key commands are a present accelerator. Key commands are faster than accessing pull down menus. However, the desktop has limited use of key commands, and key commands are hidden behind a mysterious F-key or awkward key combinations. The other conventional accelerator is the alias/shortcut. Users can create a “transport” and place it anywhere a file or folder can go. The user accesses the alias and goes directly to the “real location”. This accelerator has dedicated places in the GUI. For example, WINDOWS has the taskbar and APPLE the dock.

A number of other computer GUIs have been developed, but have been unsuccessful in attempting to dethrone the current desktop. These GUIs can be categorized as Desktop Improvements, Window Managers, 3D Environments, Zoomable User Interfaces, and 3D TreeMaps. The BUMPTOP GUI by the University of Toronto's Dynamic Graphics Project gives users the ability to move and organize desktop files in a more realistic way. Files are represented like playing cards and can be stacked, shuffled, and pushed around like paper on a real desktop. However, these features never improve navigation efficiency in a hierarchy.

Linux's NOVELL has the ability to have multiple desktops. Like sides of a cube, each desktop can rotate to reveal another desktop. Linux NOVELL seems to realize the limited space and visibility of the desktop level and tries to expand it into multiple surfaces. However, Linux NOVELL deals with a very limited amount of data. This improved access to data will only have a minimal positive impact on user efficiency.

3D-SPACE VFS (Visual File System) by software developer Marc Moini allows for navigation and launching files, but it does not allow for the creation of folders or transferring content. Files and folders are spread out across translucent planes. Cluttered views are created in an attempt to display more than one level of information at a time. A disconnect occurs in the folder metaphor when a folder is opened and it tears off to become a plane. An attempt is made to constrain 3D navigation but the user's movements are not constrained enough causing ineffective views, wild movements, and overall difficult interaction.

New windowing features are a popular area of exploration. Windows can become transparent to see the content behind them. Often windows are slightly slanted in a perspective view to make room to view multiple windows at once as in PROJECT LOOKING GLASS.

THREE DIMENSIONAL WORKSPACE MANAGER (3DWM) and Microsoft's TASK GALLERY allow windows to be mapped onto 3D cubes or inside room surfaces. One reason for window managers is to have the ability to view more windows. This is an attempt to improve the visibility of the hierarchy. The user can have more open windows on screen so the user can see more. More recently APPLE incorporated a feature called EXPOSÉ. At the press of a button users can instantly tile or hide all open windows. Tiling windows makes them all visible at one time filling the screen space. Then the user can choose one window to bring to the front and make it active. Another reason for a window manager is to have enough windows open to reduce the need to go back to the hierarchal files and folders.

Three-dimensional environments create interesting visualizations. Unfortunately they have drawbacks as well. TACTILE 3D is a newer interface by Upper Bounds Interactive. It turns files, folders, and windows into 3D spheres. TACTILE 3D is nearly the same as the desktop but instead of flat windows the user works within 3D rooms. All the same limited visibility problems as the desktop come with TACTILE 3D. The big difference is the added complexity of interaction.

CROQUET was developed by Viewpoint Research Institute Inc. CROQUET is a multi-user 3D environment. The environment contains windows, rooms, and portals. CROQUET allows a user to become an avatar able to move to windows and portals. CROQUET has similarities to the current desktop. Users have the ability to travel within levels or transport through portals to different levels. However the ground level view makes it impossible to get an overview of contents within a level. The use of portals to access other environments creates poor visibility. To understand and become familiar with an entire system of rooms connected by portals would be very difficult because of the inability to display an overview of data.

TREE CONES by the Xerox Palo Alto Research Center was designed to view more information than the desktop and to be more efficient for the user. When a container is opened, leader lines are projected. At the end of the leader lines are the files and the children folders. However, occlusion within each level makes it difficult to find information, which results in less efficiency. 3DOSX by MacWarriors from the University of Illinois at Urbana-Champaign is a system based on TREE CONES. 3DOSX has a few major differences from TREE CONES. One difference is that 3DOSX limits occlusion within each level. An open folder is represented as a circular platform, like a Lazy Susan. Using left and right arrow keys, users can reveal a limited amount of files and folders while hiding the rest. While occlusion is prevented, hiding objects decreases visibility. Another big difference with 3DOSX is that it adds the ability to rotate freely around the world. When the Lazy Susan rotates, connected platforms in that hierarchy are also affected by rotating all around the 3D environment. A disconnect in the metaphor results when a folder turns into a platform when it is opened. The constantly changing environment and visually similar platforms make it difficult for users to develop a cognitive map and navigate directly to a desired location. In general, TREE CONES have some additional negative qualities, such as the distance between parent and child folders and inconsistent location of content. TREE CONES suffer from occlusion while 3DOSX offers hidden content.

The following is an example of a Zoomable User Interface (ZUI). ZOOM WORLD by Jef Raskin is a prototype interface, which was produced for evaluation. ZOOM WORLD is truly different since folders cannot be found. Raskin describes this as “all content”. All the user's files are displayed on a flat wall. The user then has the ability to smoothly zoom-in and out of areas of interest as well as pan. Contents are not hidden in folders so everything is revealed. The user has the ability to create customized labels, like street signs, that inform the user what is deeper in certain areas. This is where the prototype ends. There is no need to launch a file within an application. This has been called the plain paper metaphor. Bring the tools to the file and not the file to the tools.

THREE-DIMENSIONAL TREEMAPS are modifications to Ben Shneiderman's TREEMAPS. TREEMAPS were created to provide computer administrators the ability to see where and who was using the largest amounts of hard drive space in multi-user computers. Squares within squares represent hierarchy while the size of squares is dependent on the size of the content within. With today's larger hard drives this is not as much of a problem as it used to be. When considering TREEMAPS as a browser a negative aspect would be the importance that would be given to a printed catalog over an on-line catalog. Both files may have the same content but the printing file would get more importance over an on-line file because of the normally larger sizes required for print images. Understanding parent/child relationships and/or hierarchy can be difficult when viewing TREEMAPS. TREEMAPS' purpose is to navigate and see patterns in data (filtering different file types is also possible). It is not designed to be a replacement to the desktop.

STEPTREE by Thomas Bladh from the Blekinge Institute of Technology is a 3D representation of TREEMAPS. STEPTREE stacks both folder and files boxes on a single base platform to provide a visual representation of hard drive capability and utilization. In this visual representation, the size of each box is a function of the subject files size and the program merges all data into one box like structure. The boxes can not be moved and labels are not provided on the individual boxes. Zooming capabilities are limited to six or less levels. To access more information, the user chooses a sub-container and the original set of data disappears except for the chosen container that moves front and center. Files are clustered causing lanes of files to form on nearly all containers and obscuring other containers.

Most 3D environments have completely occluded objects, which requires the user to perform complex 3D interaction. Current 3D interaction tools are also expensive and difficult to learn and use. Two-dimensional pointing devices for rotation in a 3D environment are also difficult to master. Users can lose orientation and produce ineffective views.

### DISCLOSURE OF THE INVENTION

With parenthetical reference to the corresponding parts, portions, or surfaces of the disclosed embodiment, merely for purposes of illustration and not by way of limitation, the present invention broadly provides an improved computer-implemented graphic user interface (14) comprising a first platform (22) representing a first level of data organization and having a front surface (40) and a top surface (41), a second platform (26b) representing a second level of data organization within the first level of data organization and having a front surface and a top surface, the second platform stacked on the first platform and scaled relative to the first platform such that the top surface of the second platform is smaller than the top surface of the first platform. The second platform may be scaled relative to the first platform such that the top surface of the second platform is half the size of the top surface of the first platform. The second platform may be scaled relative to the first platform such that the front surface of the second platform is smaller than the front surface of the first platform. The interface may further comprise a third platform (26a) representing the second layer of data organization within the first level of data organization and having a front surface and a top surface, the second platform and the third platform stacked on the first platform, and the second platform and the third platform scaled relative to the first platform such that the top surfaces of the second and the third platforms are smaller than the top surface of the first platform. The second platform and the third platform may be scaled relative to the first platform such that the front surfaces of the second and third platforms are smaller than the front surface of the first platform. The front surface of the first platform may comprise a label (45a) and the front surface of the second platform may comprise a label (45c) and the label may comprise a graphic image. The interface may further comprise a file panel (36) representing individual data files associated with the second platform. The interface may further comprise a saved view panel (35) representing saved perspectives or magnifications of the platforms, and/or a path bar (37) representing parent levels for a selected platform. The interface may further comprise a third platform (32) representing a third level of data organization within the second level of data organization and having a front surface and a top surface, the third platform stacked on the second platform, and the third platform scaled relative to the second platform such that the top surface of the third platform is smaller than the top surface of the second platform. The third platform may be scaled relative to the second platform such that the front surface of the third platform is smaller than the front surface of the second platform. The interface may further comprise a file panel (36) representing individual data files associated with the third platform.

An another aspect, the invention provides a system for organizing and displaying digital files or data comprising a processor (21), a display (16) communicating with the processor, a graphic user interface viewable on the display, the graphic user interface comprising a first platform representing a first level of data organization and having a front surface and a top surface, and a second platform representing a second level of data organization and having a front surface and a top surface, the second platform stacked on the first platform and the second platform scaled relative to the first platform such that the top surface of the second platform is smaller than the top surface of the first platform, and data files (48) associated with the second platform. The system may further comprise a user input device (18, 19, 20) communicating with the processor. The graphic user interface, input device and processor may be adapted to selectively move (49) platforms. The graphic user interface, input device and processor may be adapted to selectively display the files associated with the second platform, and the files may be displayed in a file panel (36) on the display. The graphic user interface, input device and processor may be adapted to selectively zoom in on (54) and zoom away from (55) a selected platform or a stack of the platforms and/or selectively pan across the platform or a stack of the platforms. The graphic user interface, input device and processor may be adapted to selectively label (45) the platforms and/or to selectively add graphical landmarks to the platforms. The graphic user interface, input device and processor may be adapted to selectively provide a split screen (57) on the display. The graphic user interface may be adapted to selectively increase or decrease the size of the top surfaces of the first platform and the second platform when a third platform is stacked on the first platform. The user input device may have a split screen activation key (56) and a split screen deactivation key (56), a saved views panel activation key (58) and saved views panel deactivation key (58), and/or a file panel activation key (51, 52, 53) and file panel deactivation key (51, 52, 53). The graphic user interface and the processor may be adapted to selectively sort the files or the platforms alphabetically, manually, by size or by date modified. The graphic user interface, input device and processor may be adapted to center the graphic user interface on a selected platform or a stack of the platforms. The platform may have a height y and a width x and an x-y ratio, the display may have a height y and a width x and an x-y ratio, and the platform x-y ratio may be substantially the same as the display x-y ratio. The data files may be displayed on the display when a user-controlled pointer (60) is passed over the second platform. The second platform may be graphically highlighted. The graphic user interface, input device and processor may be adapted to selectively search the platforms by at least one search criteria, the files or platforms meeting the search criteria may be graphically highlighted, the graphical highlight may be a flag, and the graphic user interface, input device and processor may be adapted to selectively zoom in on the graphically highlighted platform.

In another aspect, the invention provides a computerized method for providing a user interface comprising providing a screen viewable to a user, displaying on the screen a first platform representing a first level of data organization and having a front surface and a top surface, displaying on the screen a second platform stacked on the first platform, the second platform representing a second level of data organization within the first level of data organization and having a front surface and a top surface, scaling the second platform relative to the first platform such that the top surface of the second platform is smaller than the top surface of the first platform. The second platform may be scaled relative to the first platform such that the top surface of the second platform is half the size of the top surface of the first platform. The second platform may be scaled relative to the first platform such that the front surface of the second platform is smaller than the front surface of the first platform. The method may further comprise the steps of displaying on the screen a third platform stacked on the first platform, the third platform representing the second level of data organization within the first level of data organization and having a front surface and a top surface, and scaling the second platform and the third platform relative to the first platform such that the top surfaces of the second and third platforms are smaller than the top surface of the first platform. The second platform and the third platform may be scaled relative to the first platform such that the front surfaces of the second and third platforms are smaller than the front surface of the first platform. The method may further comprise the step of labeling the front surface of the first platform and labeling the front surface of the second platform, and the label may comprise a graphic image. The method may further comprise the step of selectively displaying on the screen a file panel representing individual data files associated with the second platform, selectively displaying on the screen a saved view panel representing saved perspectives or magnifications of the platforms, and/or selectively displaying on the screen a path bar representing parent levels for a selected platform. The method may further comprise the steps of displaying on the screen a third platform stacked on the second platform, the third platform representing a third level of data organization within the second level of data organization and having a front surface and a top surface, and scaling the third platform relative to the second platform such that the top surface of the third platform is smaller than the top surface of the second platform. The third platform may be scaled relative to the second platform such that the front surface of the third platform is smaller than the front surface of the second platform. The method may further comprise the step of selectively displaying on the screen a file panel representing individual data files associated with the third platform. The method may further comprise the steps of providing a user input device, and selectively adding a platform or moving a platform as a function of the input device. The method may further comprise the step of selectively zooming in on or zooming away from a selected platform or a stack of platforms as a function of the input device, or the step of selectively panning across the platform or a stack of the platforms. The method may further comprise the step of selectively labeling the platforms or selectively adding a graphical landmark to the top or front surface of at least one of the platforms. The method may further comprise the step of splitting the screen. The method may further comprise the step of sorting the files alphabetically, manually, by size or by date modified, or the step of centering the screen around a selected platform or a stack of the platforms. The method may further comprise the steps of selectively displaying on the screen a file panel representing individual data files associated with a platform, and graphically highlighting the platform corresponding to the file panel. The method may further comprise the step of searching the platforms by at least one selected search criteria, the step of highlighting at least one platform meeting the search criteria, and the step of selectively zooming in on the graphically highlighted platform.

In another aspect, the invention provides a computer-implemented graphic user interface comprising multiple platforms representing different levels of data organization, each of the platforms having a front surface and a top surface, the platforms stacked on top of each other in levels from a base platform (22) to a top platform (30, 31, 32), the platforms scaled relative to each other such that the top surface of each of the platforms is smaller than the top surface of the platform on which it is stacked. The platforms may be scaled relative to each other such that the front surface of each of the platforms is smaller than the front surface of the platform on which it is stacked. The front surface of at least one of the platforms may comprise a label or graphic image (45). The graphic user interface may further comprise a file panel representing individual data files associated with a selected platform, a saved view panel representing saved perspectives or magnifications of the platforms, and/or a path bar representing parent levels for a selected platform.

In another aspect, the invention provides a computerized method for providing a user interface comprising displaying on a screen viewable to a user multiple platforms representing different levels of data organization, each of the platforms having a front surface and a top surface, stacking the platforms on top of each other in levels from a base platform to a top platform, and scaling the platforms relative to each other such that the top surface of each of the platforms is smaller than the top surface of the platform on which it is stacked. The platforms may be scaled relative to each other such that the front surface of each of the platforms is smaller than the front surface of the platform on which it is stacked. The method may further comprise the step of labeling at least one of the platforms. The method may further comprise the step of displaying on the screen a file panel representing individual data files associated with a selected platform when a user-controlled pointer (60) is passed over the selected platform. The method may further comprise the step of displaying on the screen a saved view panel representing saved perspectives or magnifications of the platforms, and/or the step of displaying on the screen a path bar representing parent levels of a selected platform.

In another aspect, the invention provides a computer-readable medium having computer-executable instructions for performing a method comprising displaying on a screen viewable to a user multiple platforms representing different levels of data organization, each of the platforms having a front surface and a top surface, stacking the platforms on top of each other in levels from a base platform to a top platform, and scaling the platforms relative to each other such that the top surface of each of the platforms is smaller than the top surface of the platform on which it is stacked. The platforms may be scaled relative to each other such that the front surface of each of the platforms is smaller than the front surface of the platform on which it is stacked. The method may further comprise labeling at least one of the platforms. The method may further comprise displaying on the screen a file panel representing individual data files associated with a selected platform when a user-controlled pointer is passed over the selected platform. The method may further comprise displaying on the screen a saved view panel representing saved perspectives or magnifications of the platforms and/or displaying on the screen a path bar representing parent levels of a selected platform. The method may further comprise selectively adding a platform or moving a platform, selectively zooming in on or zooming away from a selected platform or a stack of platform, and/or selectively panning across a platform or a stack of the platforms. The method may further comprise sorting the files alphabetically, manually, by size or by date modified, searching the platforms by at least one selected search criteria, and highlighting at least one platform meeting the search criteria.

The general object is to provide an improved three dimensional graphic user interface. This and other objects and advantages will become apparent from the foregoing and ongoing written specification, the drawings, and the appended claims.

### BRIEF DESCRIPTION OF THE DRAWINGS

FIG. 1 is a schematic of the preferred embodiment of the improved display system.

FIG. 2 is a view of the graphic user interface used in the system shown in FIG. 1.

FIG. 3 is an enlarged view of a stack shown in FIG. 2.

FIG. 4 is a representation of the zoom and pan function moving from the view of FIG. 2 to the view of FIG. 3.

FIG. 5 is a view of the split screen mode.

FIG. 6 is a representation of the transfer of a platform using the split screen mode shown in FIG. 5.

FIG. 7 is the graphic user interface of FIG. 2 with a saved views panel.

FIG. 8 is an enlarged view of a stack shown in FIG. 2 with a file panel.

FIG. 9 is an enlarged view of the user control device shown in FIG. 1.

FIG. 10 is an enlarged view of a stack shown in FIG. 2 with a path bar.

FIG. 11 is a view of the multiple window mode.

FIG. 12 is a representation of the full zoom out mode.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

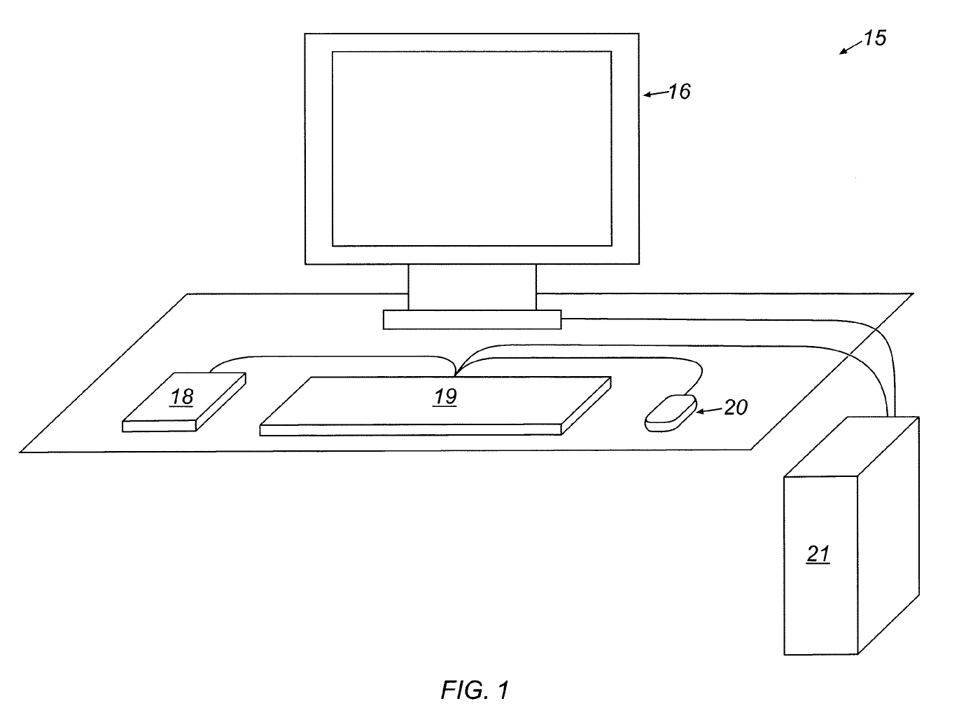

Referring now to the drawings, and more particularly, to FIG. 1 thereof, this invention provides an improved user interface system, of which the presently preferred embodiment is generally indicated at 15. As shown in FIG. 1, system 15 broadly includes a display screen 16, a keypad 18, a keyboard 19, a mouse 20, and a processor 21 in communication with display 16 and user input devices 18-20. While a display, keypad, keyboard and mouse are described in this embodiment, alternate user input interfaces may be used. For example, system 15 may be used with devices having touch screen capabilities, where the user is given the ability to touch the screen with his fingers, hands or stylist and to perform maneuvers that the device can interpret and respond to. For example, the zoom function could be activated by placing a finger and thumb together on a touch screen and then spreading the two apart.

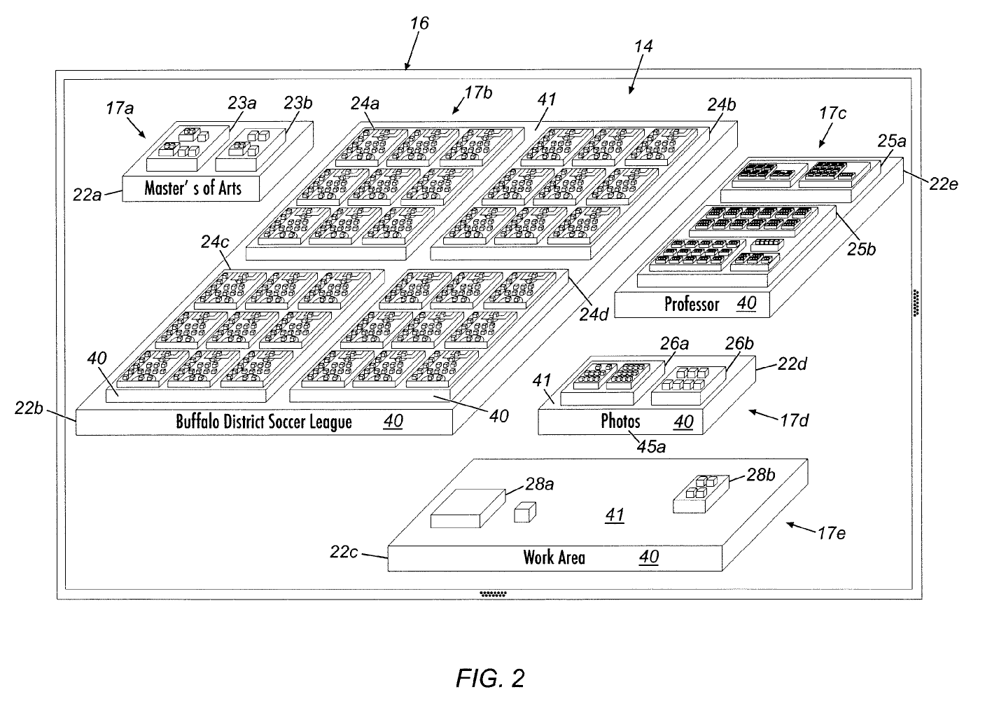

As shown in FIG. 2, system 15 employs a GUI 14 that organizes information and data in stacked 17 three dimensional platforms 22-32. Platforms 22-32 are similar to folders in the desktop system but, like children's building blocks, can be easily stacked 17 and moved 49 on screen 16 using mouse 20. The first or base level of information is shown as a 3D platform 22. Label names and/or graphics 45 are surface mapped onto the front 40 of each platform. This basic connection between the object and name allows users to become familiar with the object faster. The image and text of interface 14 creates a two-way connection. Smaller sub-platforms are stacked one on top of the other to form platform structures or stacks 17. Stacking creates partial occlusion. Like a skyscraper or a pyramid, it is easy to see the relationship between a base level 22 and the next level placed on top of it 23-28. To avoid full occlusion, interface 14 utilizes stacked platforms or platform structures 17 of varying sizes, with each child platform 23-28 half the height of its parent platform 22.

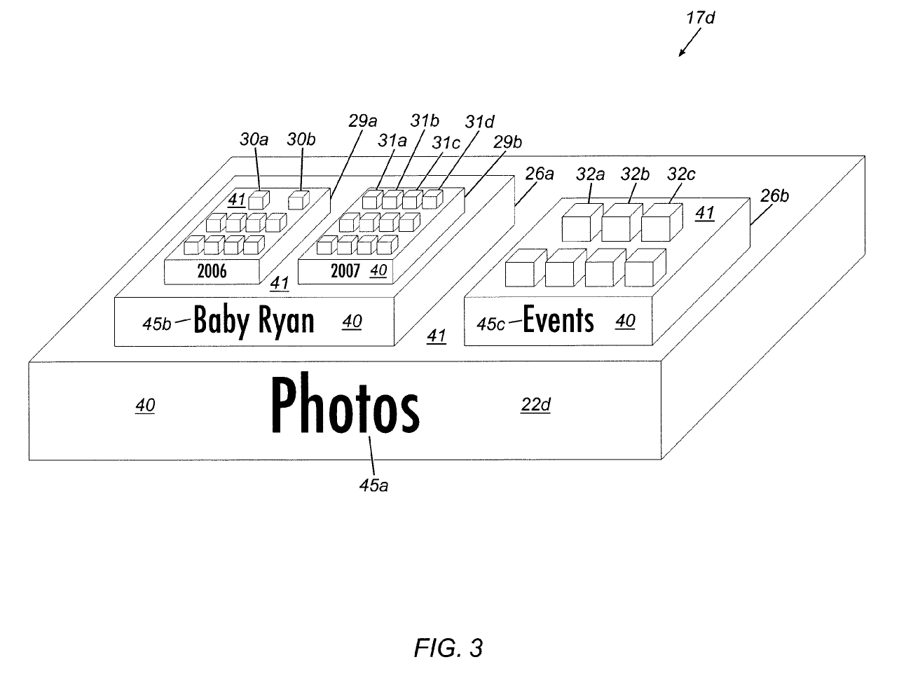

Thus, with further reference to FIG. 2, the first level of organization is provided in first level or base platforms 22. Platforms 22a-e are visually represented in interface 14 on display 16 as the broadest level of organization. Stacked on each of platforms 22a-e is a second level of organization represented by platforms 23-28, respectively. Accordingly, with reference to FIG. 3, a first platform 22d is provided that is labeled 45 by a user in the preferred embodiment as “Photos” on front surface 40. Within this platform, which is analogous to a folder in a conventional windows system, are subcategories of organized data, represented by platforms 26a and 26b labeled 45b “Baby Ryan” and 45c “Events”, respectively. This second level of platforms 26 is analogous to a subfolder. However, rather then having to open a folder entitled “Photos” to see what subfolders are contained therein, interface 14 allows for those subcategories to be immediately viewable to the user in three dimension stack 17d. Thus, platforms 26a and 26b are stacked on first level platform 22d. In turn, second level platform 26a contains two third level platforms 29a and 29b, labeled “2006” and “2007”, respectively. Third level platforms 29 in turn contain fourth level platforms 30 and 31, labeled with the months of the year. Platforms 30 and 31 will then each contain individual files or photographs 48. Using this 3D stacked platform visualization metaphor 14, the user does not have to navigate through multiple levels to view folders within folders. Rather than a user looking inside a folder and only seeing the contents of the next level in that folder, the user can immediately see multiple levels of stacked platforms 17.

This stacking process can go on and on. Each successive platform's height is 50% smaller than its parent platform. Platforms do not extend beyond the indicated area of the parent platform's top surface 41. This prevents complete occlusion relating to different directories. Hierarchy can therefore be clearly visualized by stacking Different numbers of platforms and levels result in differently sized and visually distinct platform structures 17. In the preferred embodiment, platform sizes are not determined by file size. Platform sizes are determined in a top-down approach.

Lower level platforms, or parent platforms, are automatically enlarged to accommodate newly added child platforms. The highest-level platform 30-32 is cube-shaped. Each parent platform is large enough to support the children platform(s) stacked on it. This process continues all the way to the largest base platform, creating stacked platform structures 17. Most likely the user will have several platform structures 17a-e displayed on screen 16, representing the user's data or applications. Different looking structures as well as sub-structures give the user a better opportunity to recognize and learn the locations of content over the desktop. Since entire platform structures can be visualized, they have a better opportunity to be visually distinct over the desktop. More consistent locations also aid in remembering locations of data or applications.

The user's view angle is fixed, and is called God's eye view or a ¾ view. An enhancement of interface 14 is that the user has an oblique projection of content. This allows identically sized objects in the background to have the same size and visual importance as objects in the foreground. Z-axes lines are rendered at a 45-degree angle. This allows platforms and platform stacks 17 to have a similar ratio of height to width to fit screen 16. Three-dimensional visualizations usually require users to navigate around and over objects to see objects beyond them. System 15 eliminates the possibility of complete occlusions to any object because of the described placement and scaling.

If a platform does not extend beyond the top borders 41 of its parent platform or the other platforms on the same level, complete occlusion will not occur. This eliminates the need for complex 3D interaction. System 15 still uses mouse 20 for 2D pointing, since pointing 60 only needs to occur in a 2D fashion.

All the platforms within a single level can be arranged alphabetically. The user may also manually arrange content within a level according to the user's personal preference. To accomplish this, the user selects the parent platform. A pull down menu accesses a custom mode. The user clicks and drags the platform(s) to the desired locations. The parent platform automatically expands and contracts supported platform(s) to fit the subject platform(s) on its top surface 41.

Constantly changing sorting variations can change the arrangement of platform structures. Typical sorting variations are alphabetical, size, and date modified. Sort variations can be displayed in the reverse order as well. For users to remember locations of data, it can be counterproductive to have too many sorting options. Every time the platform formations are rearranged it requires the user to relearn the locations of the information effected. In interface 14, platforms can be sorted within a level alphabetically or manually. Other sorting variations can be applied to files, which are discussed later.

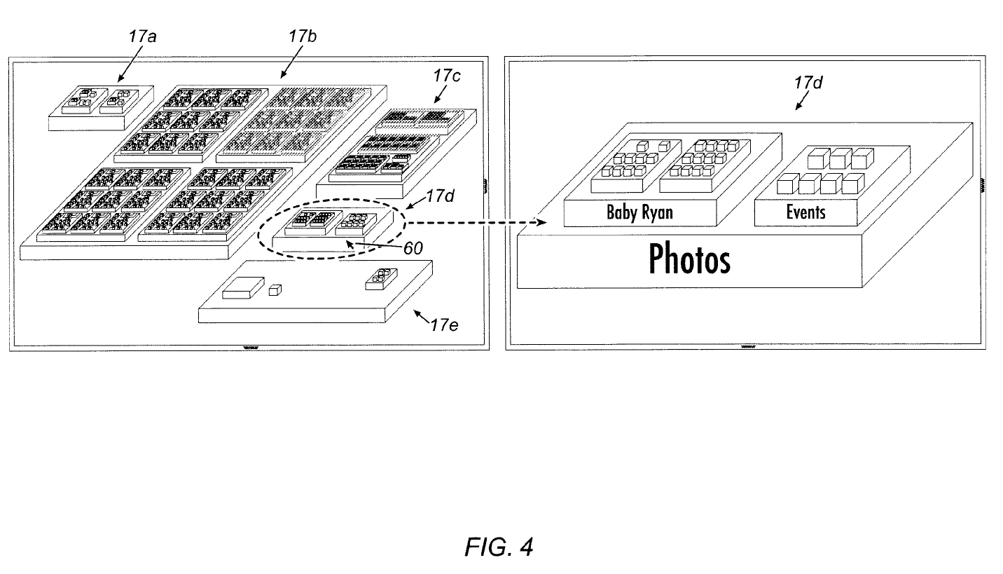

In the preferred embodiment, all of the platforms are open or viewable in the GUI at all times. Since children platforms' heights are continuously scaled 50% and all platforms are open for display, the only required user navigation actions are zooming and panning Zooming controls 54, 55 and 59 and panning controls are sufficient for the user without any need for axis rotations. As shown in FIG. 4, by pointing to an area of interest with pointer 60 and clicking, the visualization system centers on the clicked location. The mouse is more efficient in this system than the desktop. Centering content is more forgiving since it only depends on the user's general feel and not an exact area. Pressing the up key on keyboard 19 or key 54 on pad 18 zooms into the content or platform. Zooming is an animation that occurs over a limited amount of frames. The animation helps prevent the user from becoming confused and disoriented. Without animation the viewed elements would jump. Users can zoom until the desired information is at the desired magnification. A closer more detailed view of additional content may become visible. This can be a relatively infinite process. Centering and zooming in and out is the navigation focus for system 15. This navigation gives a sense of freedom because it is not tied down to travel within individual folders. The down key on keyboard 19 or key 55 on pad 18 allows users to zoom-out to eventually get an overview of all the information or stacks on screen 16. This is called the rapid zoom technique. When contents are scaled to the users desire, often contents nearby are slightly off the viewable screen area so additional manual panning is available. Through the press and hold of a button, the user can drag all the platforms together 2-dimensionally. This technique can be used to make small navigation movements.

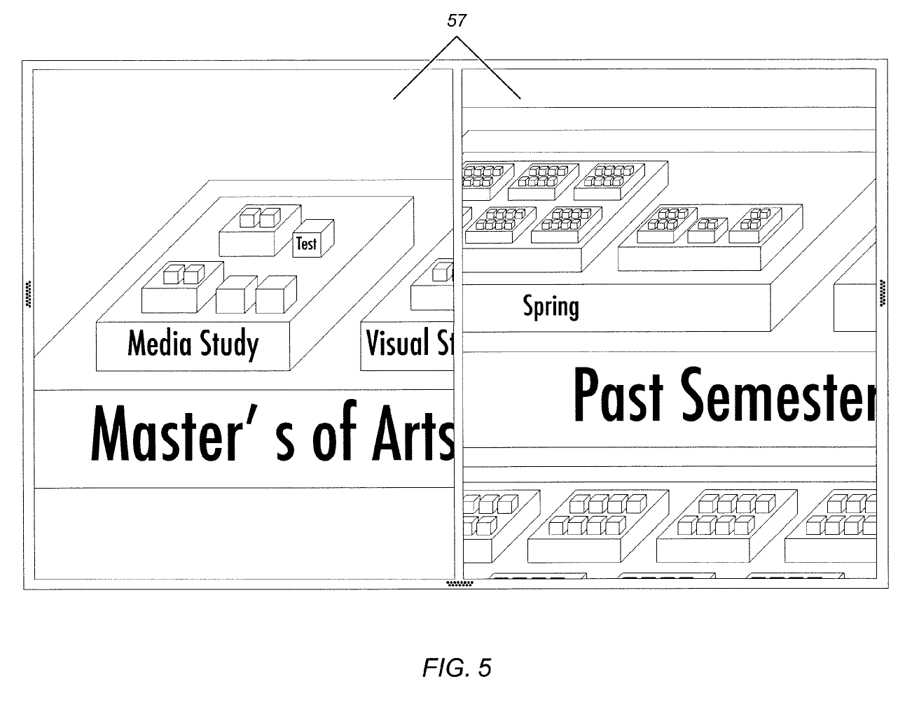

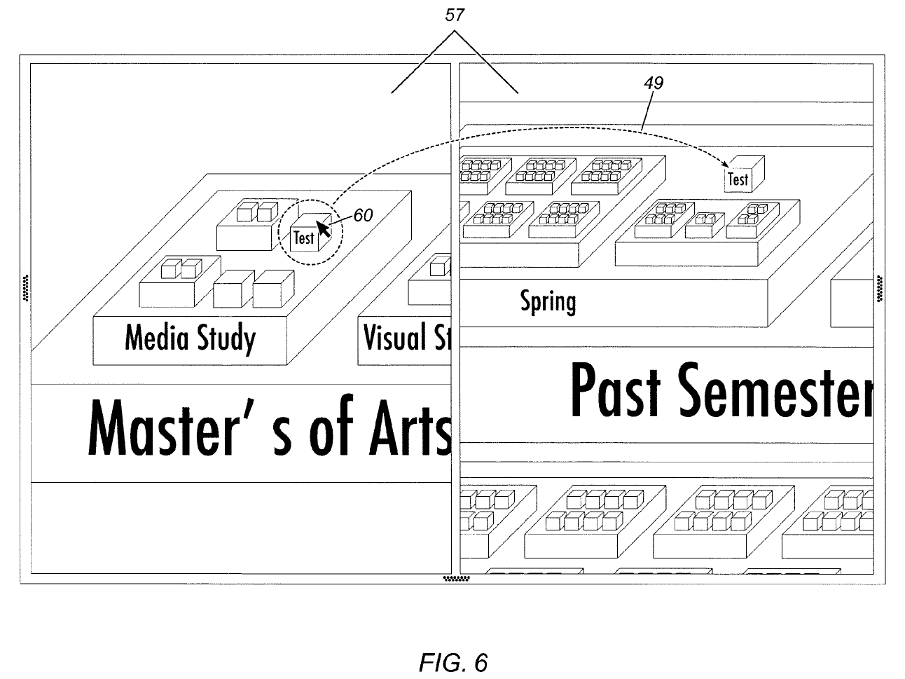

Moving folders to different locations is a common task in the desktop system. In the same way, users are allowed to transfer platforms to other locations in system 15. As shown in FIG. 5, a key command creates a split screen 57 in the platforms view screen 16, allowing users to navigate on each side. Users are then able to move 49 a platform by selecting the platform, dragging it across the split screen to the other platform view screen, and then releasing the platform in the new location, as shown in FIG. 6. The parent platform automatically expands to accommodate the additional platform. If applicable, the old parent platform may also decrease in size.

In the preferred embodiment, the X, Y, and Z-axis's of all platforms are the same. Even though different shaped platforms could aid the user in remembering locations, they would take up more space, ultimately requiring the user to do more navigating. As mentioned above, transferring 49 platforms may affect the size and layout of the parent platforms. A platform's ratio should therefore be similar to the monitor. A specific ratio like 4:3 or widescreen is not needed because zooming in and out is a free flowing travel. The location the platform is transferred from can get smaller, and the location the platform is transferred to can get larger. In the same way all the parent platforms may be affected. Other stacks may also be affected and may need to be spread apart from each other. The radiating effect of parent platforms adapting in size throughout the system when content is changed is minimal. The growth is distributed to all the parent platforms in as inconspicuous a manner as possible. If a platform is promoted or demoted to a different level, the height increases when promoted, or decrease when demoted, to accommodate the level it is placed in. When a level is zoomed to fit to screen, the labels 45 within that single level are preferably all large enough to be read while fitting within the screen. This limits the amount of navigation required. As described below, path bar 37 can help if the labels 45 cannot be read while a level is fit to screen 16. Also, parent platforms are compact in size. This allows a better opportunity to keep a level of information at a large enough scale to view, as well as keeping the content within the viewing screen 16. The important features to the systems restructuring of data are relative location of platforms, staying compact within a level, and keeping parent platforms' size close to the same ratio as the associated monitor 16. The user's ability to develop a cognitive map is a benefit. Because system 15 is a direct manipulation system, such that users are changing the information, they become familiar with the changing data.

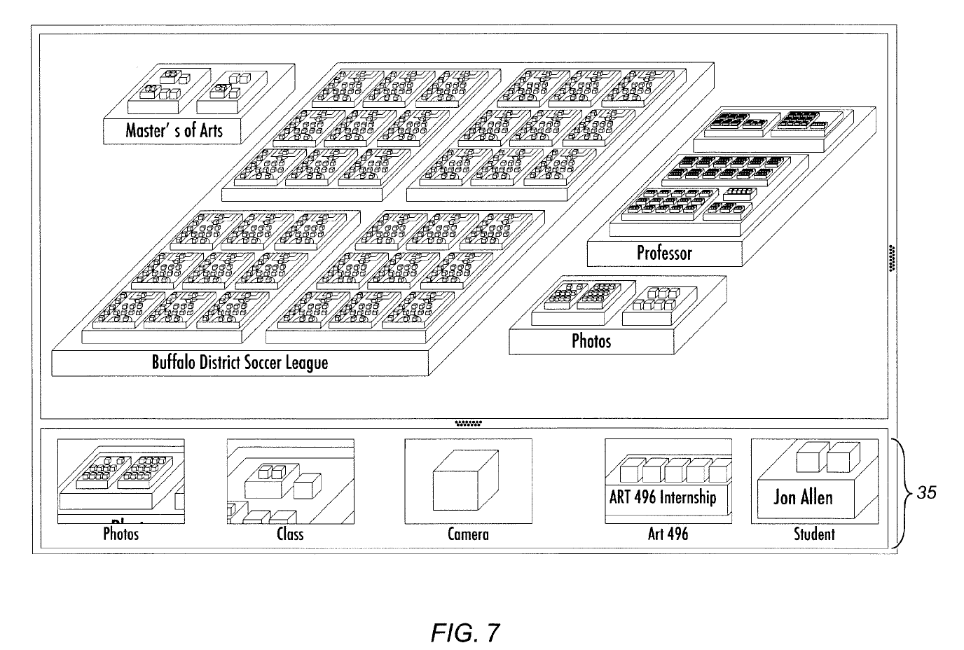

Saving a view is a common feature with 3D modeling and animation programs. As shown in FIG. 7, system 15 allows the user to create saved views in a view panel 35. Users navigate to a desired location and create a saved view by accessing a pull-down menu or by pressing a key command. A small screen capture of that image and a user-given name is stored in the saved views panel 35 located at the bottom of screen 16. A saved view is similar to a shortcut/alias in a desktop system. To instantly navigate to a saved view, the user clicks on the icon of the saved view. By mouse click or key-command 58 on pad 18 the saved views panel 35 can be revealed or hidden. Acrobat and page layout programs have a panel of page icons that can be pressed to take the user to that exact page. System 15 accesses saved views in a similar way.

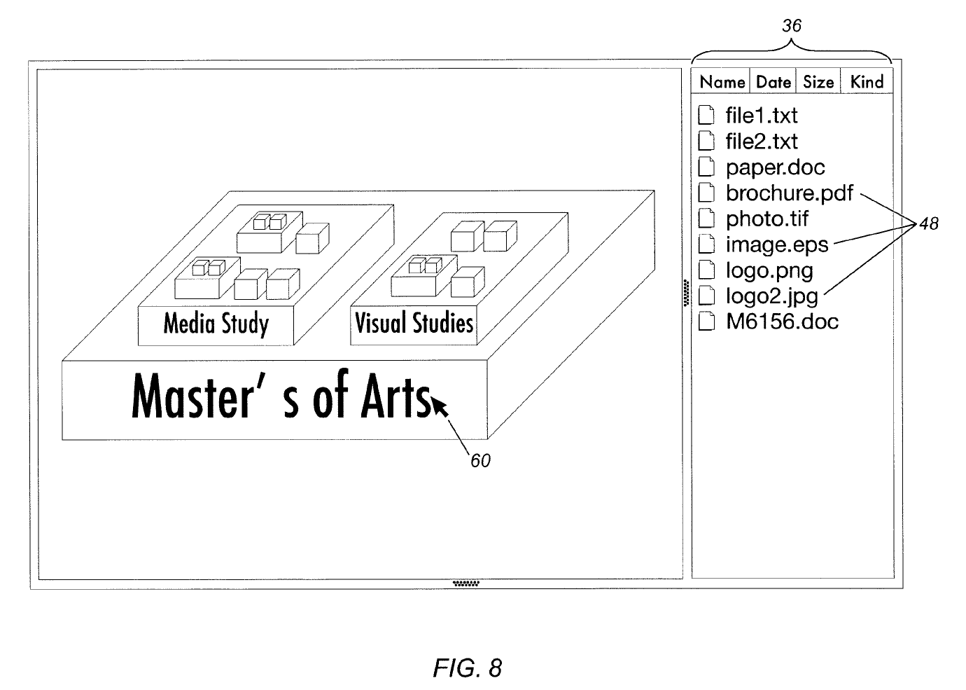

Current desktop systems combine files and folders in the same locations. Files 48 are stored or viewed separately from platforms in system 15. To access files in system 15, file panel 36 is opened. As shown in FIG. 8, rolling over a platform with pointer 60 using mouse 20 reveals the files 48 of such platform in file panel 36.

Files 48 are listed top to bottom within file panel 36. Opening and closing file panel 36 occurs with the click of a mouse or a key-command. Files are separated in an attempt to limit the amount of information in the 3D environment. In system 15, platforms are scaled so the user can see each of them on the screen and a separate view 36 of files 48 is provided so the user does not have to continually refer back to the more complex 3D structure.

In file panel 36, files 48 can be sorted alphabetically, by date, by size, or by kind. When rolling over the 3D platforms with pointer 60 using mouse 20, file panel 36 will continually display the related files 48 in the file panel 36. However, the user can use a key-command to “lock the contents”. The highlighted platform then remains highlighted while the user moves the pointer 60 to file panel 36 in order to access files 48. To transfer a file 48, the user clicks and drags the file 48 from the file list to any desired platform and releases it.

In system 15, 2D and 3D images can be attached to the top surface 41 and/or front surface 40 of any platform. For example, consider a platform containing information about a sports team and its player's. Second level platforms could then be provided on the first level platform and arranged according to their positions on the field of play. System 15 then allows the user to draw simple lines on the top surface 41 of the platform to create helpful landmarks.

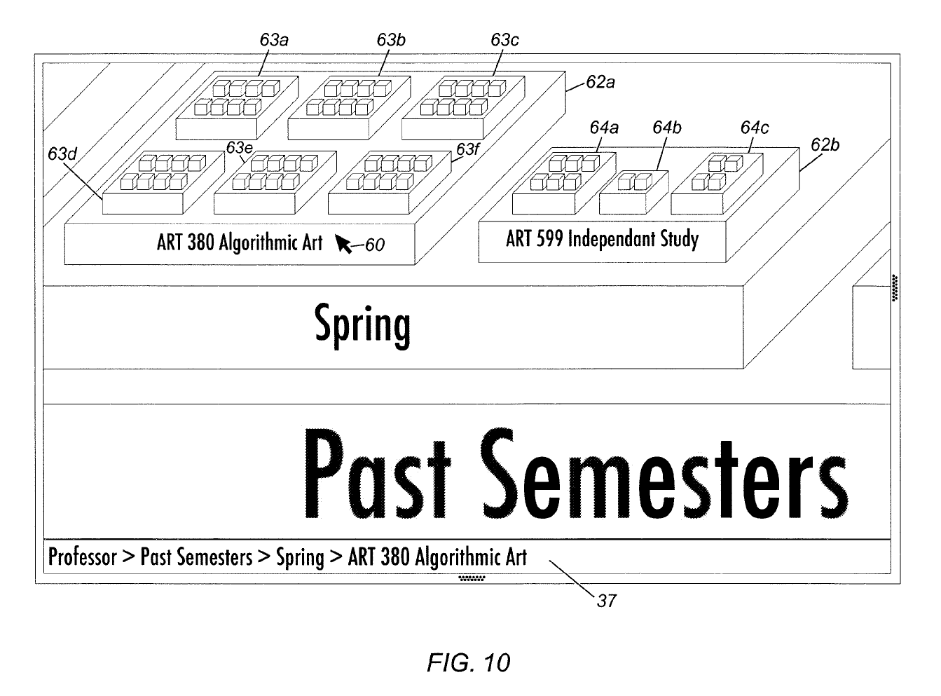

Allowing the user to take preexisting objects and to place them on a platform's top surface 41 is another method in system 15 for creating landmarks. Landmarks can also be the boundary lines on a field, goal posts, scoreboard or bleachers. These 3D landmarks follow the same rules as platforms, allowing no occlusion within a level and not going beyond the border of the parent platform's top surface. As another example, as shown in FIG. 10, system 15 would allow a teacher to create platforms 62a and 62b for each class she teaches and to create second level platforms 63 and 64 for each student in that class with the student platforms arranged similarly to how they are seated in class. In this case, the student platform 63 or 64 also acts as a landmark. This example shows how spatial memory in the real world can be carried over to system 15.

When searching for contents in the desktop system, typically the user is looking for a particular set of characters in a folder name, file name or within the contents of a file. The results are displayed in a list view. In system 15, a pull down menu or key-command opens a search window. A flag is produced every time a search hit occurs. The flag appears in the platform's view screen 16 in the location where the hit is found. The flags can be different colors depending on the file or platform meeting the search requirements. The flag also states the full name of the file or platform found. Seeing these flags across interface's 14 3D landscape gives the user a better sense of location compared to the current desktop system. Typically in current desktop systems, after a search produces results, a user clicks within a list and never learns the location of the data. The next time the user needs the same data it is very likely another search would be required. With system 15, clicking on a flag zooms the user to the desired location. File panel 36 is still required to access a file 48. In file panel 36, the files 48 that have met the search requirements appear highlighted, while the rest of the files 48 appear dimmed out.

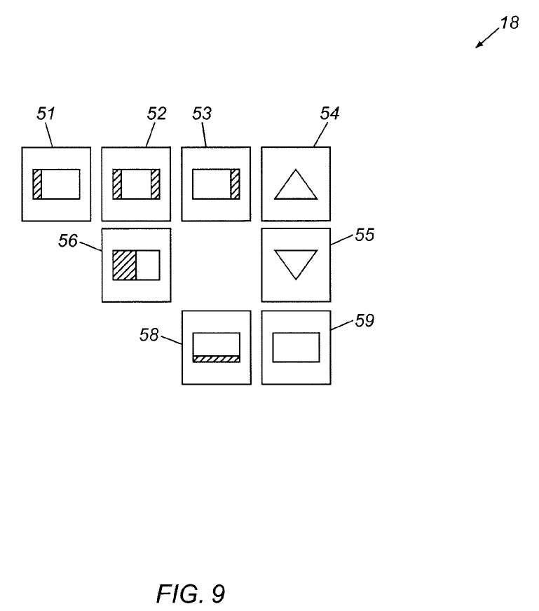

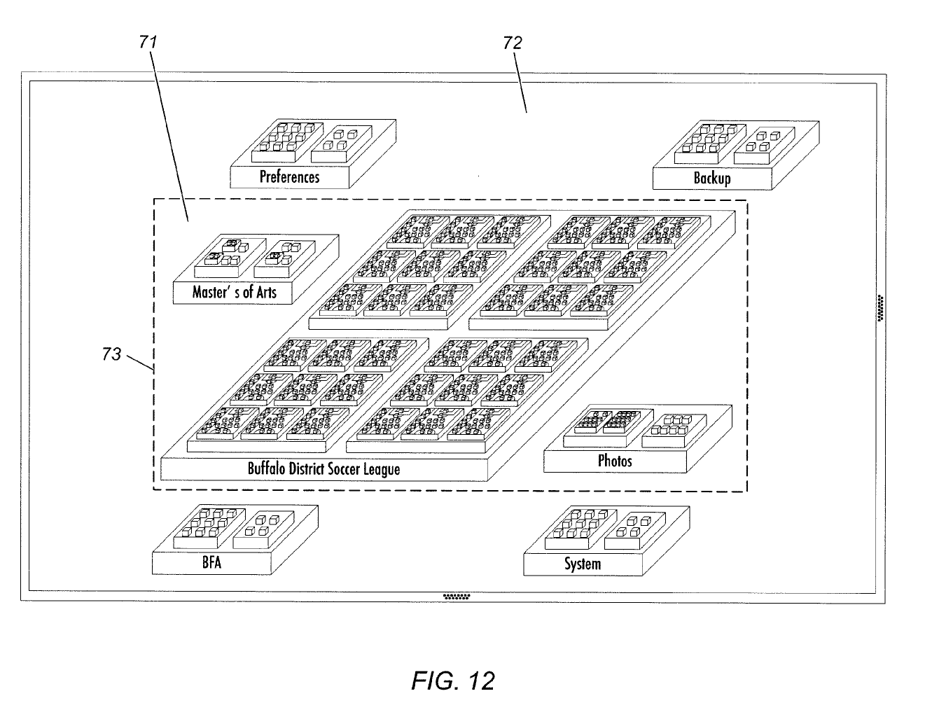

System 15 employs a separate physical keypad 18 that can be moved to either side of the keyboard for use with either hand. As a result, pointing device 20 can be used with either hand. Alternatively, common key commands on keyboard 19 can be assigned for users who do not have separate keypad device 18. System 15 depends less on pull down menus, on-screen buttons, and slow mouse interaction. A five button mouse 20 can control everything in the system view screen 16. This includes buttons dedicated to centering, zooming in, zooming out, and locking/unlocking contents. As shown in FIG. 9, keypad 18 also has a key 54 for zoom in and a key 55 for zoom out. Keypad 18 also controls the other panels, including the opening/closing 58 of the saved views panel 35, the opening/closing of the file panel 36, either on the right 53 of screen 16, on the left 51 of screen 16 or on both sides 52 or screen 16, and turning on/off 56 the split screen view 57. Keypad 18 also includes key 59 that allows the user to automatically zoom out to a view that captures all of the platforms or data. Key 59 may also be provided to allow for the user to automatically zoom out to different levels. For example, as shown in FIG. 12, an intermediate view window 71 of all commonly accessed stacks 71 and a full view window 71 of rarely accessed stacks 72 may be provided. The user can selectively zoom out to view all commonly accessed stacks 71 or the user can automatically zoom out even further to also view rarely accessed stacks or data 72. A dotted line border 73 in the fully-expanded view 72 indicates to the user which stacks are on the inside of the intermediate zoom border and therefore would be viewable in a commonly accessed view 71 and which stacks are on the outside of border 73 and are therefore only viewable in the rarely accessed zoom view 72. The user is able to drag stacks from the rarely accessed area 72 into the more commonly accessed area 71 or to drag stacks from the commonly accessed content area 71 to the rarely accessed content area 72.

When a large number of platforms are within a single level, if the user makes that level fit to screen and it is too small to read the labels on the children platforms, it can require excessive and inefficient zooming in and out as well as panning to find the desired platform within a level. As shown in FIG. 10, a solution to this problem is provided by showing the user the path of the location being pointed to. This area on screen 16 is the path bar 37. The user can pan over platforms with pointer 60 and read path bar 37 to see the platform they are accessing, which reduces navigation and improves efficiency. This can also help in situations where the user is zoomed into an area that looks similar or exactly like a different area. The path bar 37 will easily indicate to the user where they are and the parent levels for a selected platform.

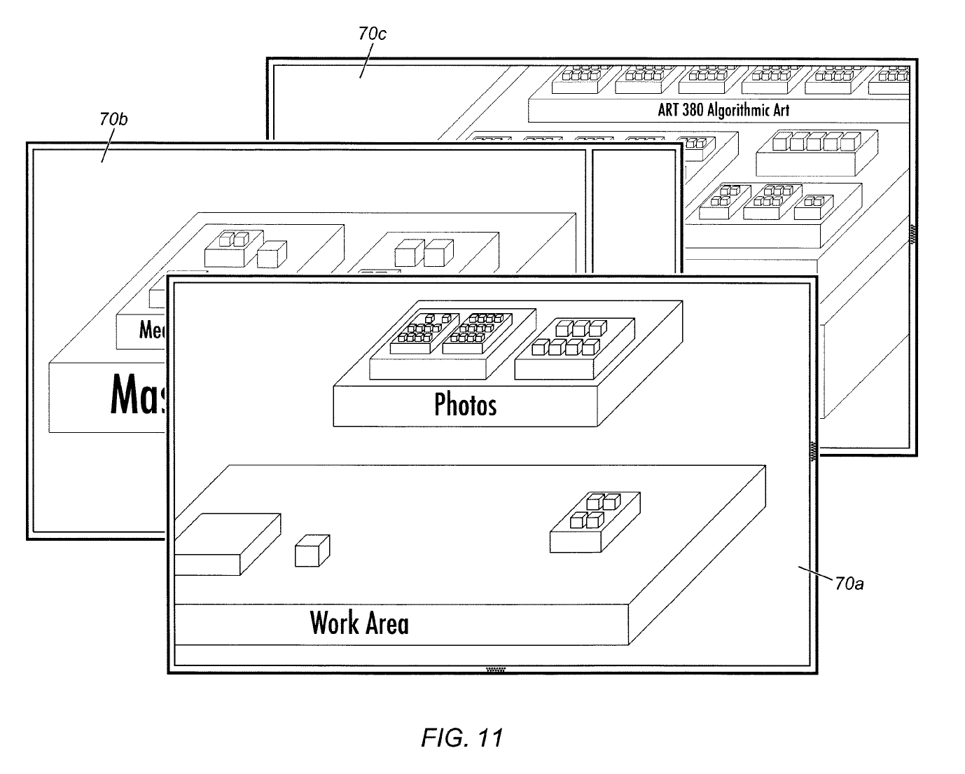

As shown in FIG. 11, system 15 also allows the user to display multiple windows 70a-c or viewing areas on a single screen. Thus, the system may be used with a conventional windows manager and allows for tiling or sorting different views of the platforms.

The user interface 14 may be integrated with a computer in a number of ways. First, it may be a stand alone application. After an independent computer Operating System (OS) is loaded, the user starts GUI 14 as an executable application. This application then accesses relevant data (such as files and folders presented by the host OS file system) and displays user interface 14 through the host operating system's native windowing system. The purpose of this executable application would be to perform general browsing functions. Alternatively, this executable application could be used for more specific purposes than general browsing. For example, within some email, photo and/or database programs, this application could be used to organize and search for files within the subject program, and the main function of the subject program would begin once the file was selected using this executable application.

Alternatively, interface 14 may be provided as a GUI replacement. Many operating systems (UNIX and UNIX-like systems such as LINUX) allow a user to specify a GUI to load on top of the operating system. GUI 14 would then be loaded as the default interface. GUI 14 would integrate with the operating system via a third-party windowing API (Application Programming Interface), such as X11.

Third, user interface 14 may be provided as an entirely new operating system, as in the preferred embodiment. In this approach, GUI 14 is integrated in its own “from-the-ground-up” operating system. Examples of existing Operating Systems with an available integrated GUI include MAC OS and MICROSOFT WINDOWS.

Finally, user interface 14 might be provided as a secondary or dual interface to a current system. With this approach, GUI 14 as well as an existing GUI (like a desktop windowing system) exists within an application or Operating System. The user is given the ability to switch between the two GUIs. This approach has a benefit in that the current desktop GUI is widely accepted. This approach lets users more slowly adapt to GUI 14. An example of a dual interface is found in the MICROSOFT WINDOWS OS. The additional interface is called WINDOWS EXPLORER. The Windows Key+E will access the interface and display a TreeView of the folder structure.

Various types of processors may be used in system 15. Some examples of processors are microprocessors, microcontrollers, CPUs, PICs, PLCs, PCs or microcomputers. Application code for GUI 14 may be embodied in any form of computer-readable medium. A computer-readable medium comprises a medium configured to store or transport computer readable code, or in which computer readable code may be embedded. Some examples of computer-readable medium are CD-ROM disks, ROM cards, floppy disks, flash ROMS, RAM, nonvolatile ROM, magnetic tapes, computer hard drives, conventional hard disks, and servers on a network. The computer systems described above are for purposes of example only. An embodiment of the invention may be implemented in any type of computer system or programming or processing environment, including personal computers, networks, and hand held devices such as cell phones, MP3 players and GPS systems.

System 15 uses visual pattern recognition to understand and remember locations, resulting in greater efficiencies. The user is able to look at the structure of information stored on processor 21, and understand where they need to navigate, and then move directly to the desired location. This is similar to looking at a globe or map. One can start by looking at the entire earth and then is able to see the desired country and then the desired city. Then within the city, one can find a certain building and then find the 5th floor and then find the room in the north-west corner. Looking at the whole gives the user a visual style they will become familiar with and that will naturally guide them in the desired direction. After recognizing the whole, the user should be able to recognize the parts that make it up. The whole is broken down into its subsections mentally processed as primitive shapes. These recognizable stacked forms 17 of information can be made of different sized platforms, colors, textures, and shadings. The described GUI gives more literal locations to content over the conventional desktop system. In a conventional desktop content is constantly being displayed in different locations. Windows are often moved all over the screen display, and content within a conventional window can appear in different locations because of scrolling within a window and may be different because of view types. This makes it impossible to remember locations of files and folders spatially. So instead users are required to remember paths, long strings of text, which have been found to be difficult for users to remember.

The present invention contemplates that many changes and modifications may be made. Therefore, while the presently-preferred form of the user interface has been shown and described, those persons skilled in this art will readily appreciate that various additional changes and modifications may be made without departing from the spirit of the invention, as defined and differentiated by the claims.

What is claimed is:

1. A computer-implemented graphic user interface comprising:
a first platform representing a first level of data organization and having a front surface and a top surface;
a second platform representing a second level of data organization within said first level of data organization and having a front surface and a top surface;
said second platform stacked on said first platform and scaled relative to said first platform such that said top surface of said second platform is smaller than and visually contained within said top surface of said first platform.

2. The graphic user interface of claim 1, wherein said second platform is scaled relative to said first platform such that said top surface of said second platform is half the size of said top surface of said first platform.

3. The graphic user interface of claim 1, wherein said second platform is scaled relative to said first platform such that said front surface of said second platform is smaller than said front surface of said first platform.

4. The graphic user interface of claim 1, and further comprising:
a third platform representing said second level of data organization within said first level of data organization and having a front surface and a top surface;
said second platform and said third platform each stacked on said first platform;
said second platform and said third platform scaled relative to said first platform such that said top surfaces of said second and said third platforms are each smaller than and visually contained within said top surface of said first platform.

5. The graphic user interface of claim 4, wherein said second platform and said third platform are scaled relative to said first platform such that said front surfaces of said second and third platforms are smaller than said front surface of said first platform.

6. The graphic user interface of claim 1, wherein said front surface of said first platform comprises a label and said front surface of said second platform comprises a label.

7. The graphic user interface of claim 6, wherein said label comprises a graphic image.

8. The graphic user interface of claim 1, and further comprising a file panel representing individual data files associated with said second platform.

9. The graphic user interface of claim 1, and further comprising a saved view panel representing saved perspectives or magnifications of said platforms.

10. The graphic user interface of claim 1, and further comprising a path bar representing parent levels for a selected platform.

11. The graphic user interface of claim 1, and further comprising:
a third platform representing a third level of data organization within said second level of data organization and having a front surface and a top surface;
said third platform stacked on said second platform;
said third platform scaled relative to said second platform such that said top surface of said third platform is smaller than and visually contained within said top surface of said second platform.

12. The graphic user interface of claim 11, wherein said third platform is scaled relative to said second platform such that said front surface of said third platform is smaller than said front surface of said second platform.

13. The graphic user interface of claim 11, and further comprising a file panel representing individual data files associated with said third platform.

14. The graphic user interface of claim 1, and further comprising a third platform not stacked on either said first or said second platform representing said first level of data organization and having a front surface and a top surface.

15. The graphic user interface of claim 14, and further comprising:
a fourth platform stacked on said third platform representing said second level of data organization within said first level of data organization and having a front surface and a top surface; and
said fourth platform scaled relative to said third platform such that said top surface of said fourth platform is smaller than and visually contained within said top surface of said third platform.

16. The graphic user interface of claim 1, and further comprising:
multiple additional platforms representing said second level of data organization within said first level of data organization, each of said additional platforms stacked on said first platform and having a front surface and a top surface; and
said first platform scaled relative to said second and additional platforms such that said top surface of said second platform and said additional platforms are collectively smaller than said top surface of said first platform.

17. A system for organizing and displaying digital files or data comprising:
a processor;
a display communicating with said processor;
a graphic user interface viewable on said display;
said graphic user interface comprising a first platform representing a first level of data organization and having a front surface and a top surface, and a second platform representing a second level of data organization and having a front surface and a top surface;
said second platform stacked on said first platform and said second platform scaled relative to said first platform such that said top surface of said second platform is smaller than and visually contained within said top surface of said first platform; and
data files associated with said second platform.

18. The system set forth in claim 17, and further comprising a user input device communicating with said processor.

19. The system set forth in claim 18, wherein said graphic user interface, input device and processor are adapted to selectively move platforms.

20. The system set forth in claim 18, wherein said graphic user interface, input device and processor are adapted to selectively display said files associated with said second platform.

21. The system set forth in claim 17, wherein said files are displayed in a file panel on said display.

22. The system set forth in claim 18, wherein said graphic user interface, input device and processor are adapted to selectively zoom in on and zoom away from a selected platform or a stack of said platforms.

23. The system set forth in claim 18, wherein said graphic user interface, input device and processor are adapted to selectively pan across said platform or a stack of said platforms.

24. The system set forth in claim 18, wherein said graphic user interface, input device and processor are adapted to selectively label said platforms.

25. The system set forth in claim 18, wherein said graphic user interface, input device and processor are adapted to selectively add graphical landmarks to said platforms.

26. The system set forth in claim 18, wherein said graphic user interface, input device and processor are adapted to selectively provide a split screen on said display.

27. The system set forth in claim 17, wherein said graphic user interface is adapted to selectively increase or decrease the size of said top surfaces of said first platform and said second platform when a third platform is stacked on said first platform.

28. The system set forth in claim 18, wherein said user input device has a split screen activation key and a split screen deactivation key.

29. The system set forth in claim 18, wherein said user input device has a saved views panel activation key and saved views panel deactivation key.

30. The system set forth in claim 18, wherein said user input device has a file panel activation key and file panel deactivation key.

31. The system set forth in claim 17, wherein said graphic user interface and said processor are adapted to selectively sort said files or said platforms alphabetically, manually, by size or by date modified.

32. The system set forth in claim 18, wherein said graphic user interface, input device and processor are adapted to center said graphic user interface on a selected platform or a stack of said platforms.

33. The system set forth in claim 17, wherein said platform has a height y and a width x and an x-y ratio, said display has a height y and a width x and an x-y ratio, and said platform x-y ratio is substantially the same as said display x-y ratio.

34. The system set forth in claim 17, wherein said data files are displayed on said display when a user-controlled pointer is passed over said second platform.

35. The system set forth in claim 20, wherein said second platform is graphically highlighted.

36. The system set forth in claim 18, wherein said graphic user interface, input device and processor are adapted to selectively search said platforms by at least one search criteria.

37. The system set forth in claim 36, wherein files or platforms meeting said search criteria are graphically highlighted.

38. The system set forth in claim 37, wherein said graphical highlight is a flag.

39. The system set forth in claim 37, wherein said graphic user interface, input device and processor are adapted to selectively zoom in on said graphically highlighted platform.

40. A system of organizing and displaying digital files or data comprising:
a processor;
a display communicating with said processor;
a graphic user interface viewable on said display;
said graphic user interface comprising a first platform representing a first level of data organization and having a front surface and a top surface, and a second platform representing a second level of data organization and having a front surface and a top surface;
said second platform stacked on said first platform and said second platform scaled relative to said first platform such that said top surface of said second platform is smaller than said top surface of said first platform;
data files associated with said second platform; and
a file panel for displaying said data files.

41. The system set forth in claim 40, and further comprising a user input device communicating with said processor.

42. The system set forth in claim 41, wherein said graphic user interface, input device and processor are adapted to selectively display said data files in said file panel.

43. A computerized method for providing a user interface comprising:
providing a screen viewable to a user;
displaying on said screen a first platform representing a first level of data organization and having a front surface and a top surface;
displaying on said screen a second platform stacked on said first platform, said second platform representing a second level of data organization within said first level of data organization and having a front surface and a top surface;
scaling said second platform relative to said first platform such that said top surface of said second platform is smaller than and visually contained within said top surface of said first platform.

44. The method set forth in claim 43, wherein said second platform is scaled relative to said first platform such that said top surface of said second platform is half the size of said top surface of said first platform.

45. The method set forth in claim 43, wherein said second platform is scaled relative to said first platform such that said front surface of said second platform is smaller than said front surface of said first platform.

46. The method set forth in claim 43, and further comprising the steps of:
displaying on said screen a third platform stacked directly on said first platform, said third platform representing said second level of data organization within said first level of data organization and having a front surface and a top surface;
scaling said second platform and said third platform relative to said first platform such that said top surfaces of each of said second and third platforms are smaller than and visually contained within said top surface of said first platform.

47. The method set forth in claim 46, wherein said second platform and said third platform are scaled relative to said first platform such that said front surfaces of said second and third platforms are smaller than said front surface of said first platform.

48. The method set forth in claim 43, and further comprising the step of labeling said front surface of said first platform and labeling said front surface of said second platform.

49. The method set forth in claim 48, wherein said label comprises a graphic image.

50. The method set forth in claim 43, and further comprising the step of selectively displaying on said screen a file panel representing individual data files associated with said second platform.

51. The method set forth in claim 43, and further comprising the step of selectively displaying on said screen a saved view panel representing saved perspectives or magnifications of said platforms.

52. The method set forth in claim 43, and further comprising the step of selectively displaying on said screen a path bar representing parent levels for a selected platform.

53. The method set forth in claim 43, and further comprising the steps of:
displaying on said screen a third platform stacked on said second platform, said third platform representing a third level of data organization within said second level of data organization and having a front surface and a top surface;
scaling said third platform relative to said second platform such that said top surface of said third platform is smaller than and visually contained within said top surface of said second platform.

54. The method set forth in claim 53, wherein said third platform is scaled relative to said second platform such that said front surface of said third platform is smaller than said front surface of said second platform.

55. The method set forth in claim 53, and further comprising the step of selectively displaying on said screen a file panel representing individual data files associated with said third platform.

56. The method set forth in claim 43, and further comprising the steps of providing a user input device and selectively adding a platform or moving a platform as a function of said input device.

57. The method set forth in claim 43, and further comprising the step of selectively zooming in on or zooming away from a selected platform or a stack of platforms as a function of said input device.

58. The method set forth in claim 43, and further comprising the step of selectively panning across said platform or a stack of said platforms.

59. The method set forth in claim 43, and further comprising the step of selectively labeling said platforms.

60. The method set forth in claim 43, and further comprising the step of selectively adding a graphical landmark to said top or front surface of at least one of said platforms.

61. The method set forth in claim 43, and further comprising the step of splitting said screen.

62. The method set forth in claim 50, and further comprising the step of sorting said files alphabetically, manually, by size or by date modified.

63. The method set forth in claim 43, and further comprising the step of centering said screen around a selected platform or a stack of said platforms.

64. The method set forth in claim 43, and further comprising the steps of:
selectively displaying on said screen a file panel representing individual data files associated with a platform; and
graphically highlighting said platform corresponding to said file panel.

65. The method set forth in claim 43, and further comprising the step of searching said platforms by at least one selected search criteria.

66. The method set forth in claim 65, and further comprising the step of highlighting at least one platform meeting said search criteria.

67. The method set forth in claim 66, and further comprising the step of selectively zooming in on said graphically highlighted platform.

68. The method set forth in claim 43, and further comprising the steps of:
displaying on said screen and not stacked on either said first or said second platform a third platform representing said first layer of data organization and having a front surface and a top surface.

69. The method set forth in claim 68, and further comprising the steps of:
displaying on said screen a fourth platform stacked on said third platform representing said second level of data organization within said first level of data organization and having a front surface and a top surface;
scaling said fourth platform relative to said third platform such that said top surface of said fourth platform is smaller than and visually contained within said top surface of said third platform.

70. The method set forth in claim 43, and further comprising the steps of:
displaying on said screen multiple additional platforms stacked on said first platform representing said second level of data organization within said first level of data organization, each of said additional platforms having a front surface and a top surface; and
scaling said first platform relative to said second and additional platforms such that said top surfaces of said second platform and said additional platforms are collectively smaller than said top surface of said first platform.

71. A computer-implemented graphic user interface comprising:
multiple platforms representing different levels of data organization, each of said platforms having a front surface and a top surface;
said platforms stacked on top of each other in levels from a base platform to a top platform;
said platforms scaled relative to each other such that said top surface of each of said platforms is smaller than and visually contained within said top surface of said platform on which it is stacked.

72. The graphic user interface set forth in claim 71, wherein said platforms are scaled relative to each other such that said front surface of each of said platforms is smaller than said front surface of said platform on which it is stacked.

73. The graphic user interface set forth in claim 71, wherein said front surface of at least one of said platforms comprises a label or graphic image.

74. The graphic user interface set forth in claim 71, and further comprising a file panel representing individual data files associated with a selected platform.

75. The graphic user interface of claim 71, and further comprising a saved view panel representing saved perspectives or magnifications of said platforms.

76. The graphic user interface of claim 71, and further comprising a path bar representing parent levels for a selected platform.

77. The graphic user interface of claim 71, and further comprising:
a second set of multiple platforms representing different layers of data organization, each of said platforms having a front surface and a top surface;
said second set of multiple platforms stacked on top of each other in layers from a base platform to a top platform;
said second set of multiple platforms scaled relative to each other such that said top surface of each of said platforms is smaller than and visually contained within said top surface of said platform on which it is stacked.

78. The graphic user interface of claim 71, wherein said scale of said base platform is a function of said platforms stacked on it.

79. A computerized method for providing a user interface comprising:
displaying on a screen viewable to a user multiple platforms representing different levels of data organization, each of said platforms having a front surface and a top surface;
stacking said platforms on top of each other in levels from a base platform to a top platform;
scaling said platforms relative to each other such that said top surface of each of said platforms is smaller than and visually contained within said top surface of said platform on which it is stacked.

80. The method set forth in claim 79, wherein said platforms are scaled relative to each other such that said front surface of each of said platforms is smaller than said front surface of said platform on which it is stacked.

81. The method set forth in claim 79, and further comprising the step of labeling at least one of said platforms.

82. The method set forth in claim 79, and further comprising the step of displaying on said screen a file panel representing individual data files associated with a selected platform when a user-controlled pointer is passed over said selected platform.

83. The method set forth in claim 79, and further comprising the step of displaying on said screen a saved view panel representing saved perspectives or magnifications of said platforms.

84. The method set forth in claim 79, and further comprising the step of displaying on said screen a path bar representing parent levels of a selected platform.

85. The method set forth in claim 79, and further comprising the step of stacking said platforms on top of each other in levels from a second base platform to a second top platform.

86. The method set forth in claim 79, comprising the step of scaling said second base platform as a function of said platforms stacked on it.

87. A computer-readable medium having computer-executable instructions for performing a method comprising:
displaying on a screen viewable to a user multiple platforms representing different levels of data organization, each of said platforms having a front surface and a top surface;
stacking said platforms on top of each other in levels from a base platform to a top platform;
scaling said platforms relative to each other such that said top surface of each of said platforms is smaller than and visually contained within said top surface of said platform on which it is stacked.

88. The computer-readable medium having computer-executable instructions for performing a method as set forth in claim 87, wherein said platforms are scaled relative to each other such that said front surface of each of said platforms is smaller than said front surface of said platform on which it is stacked.

89. The computer-readable medium having computer-executable instructions for performing a method as set forth in claim 87, and further comprising labeling at least one of said platforms.

90. The computer-readable medium having computer-executable instructions for performing a method as set forth in claim 87, and further comprising displaying on said screen a file panel representing individual data files associated with a selected platform when a user-controlled pointer is passed over said selected platform.

91. The computer-readable medium having computer-executable instructions for performing a method as set forth in claim 87, and further comprising displaying on said screen a saved view panel representing saved perspectives or magnifications of said platforms.

92. The computer-readable medium having computer-executable instructions for performing a method as set forth in claim 87, and further comprising displaying on said screen a path bar representing parent levels of a selected platform.

93. The computer-readable medium having computer-executable instructions for performing a method as set forth in claim 87, and further comprising selectively adding a platform or moving a platform.

94. The computer-readable medium having computer-executable instructions for performing a method as set forth in claim 87, and further comprising selectively zooming in on or zooming away from a selected platform or a stack of platform.

95. The computer-readable medium having computer-executable instructions for performing a method as set forth in claim 87, and further comprising selectively panning across a platform or a stack of said platforms.

96. The computer-readable medium having computer-executable instructions for performing a method as set forth in claim 87, and further comprising sorting said files alphabetically, manually, by size or by date modified.

97. The computer-readable medium having computer-executable instructions for performing a method as set forth in claim 87, and further comprising searching said platforms by at least one selected search criteria.

98. The computer-readable medium having computer-executable instructions for performing a method as set forth in claim 87, and further comprising highlighting at least one platform meeting said search criteria.

99. A computerized method for providing a user interface comprising:
displaying on a screen viewable to a user multiple platforms representing different levels of data organization, each of said platforms having a front surface and a top surface;
stacking said platforms on top of each other in levels from a first base platform to a first top platform and a second base platform to a second top platform, wherein said first base platform and said second base platform represent a first and same level of data organization; and
scaling said platforms relative to each other such that said top surface of each of said platforms is smaller than said top surface of said platform on which it is directly stacked.

100. The method set forth in claim 99, a further comprising the step of stacking multiple top platforms on said base platform.
